(19) United States
(12) Patent Application Publication
(10) Pub. No.: US 2026/0156542 A1
(43) Pub. Date: Jun. 4, 2026

(54) SELECTION OF MOBILITY TIMER VALUE IN WIRELESS COMMUNICATIONS

(71) Applicant: LG ELECTRONICS INC., Seoul (KR)

(72) Inventors: Siyoung CHOI, Seoul (KR); Sunghoon JUNG, Seoul (KR); Sangwon KIM, Seoul (KR); Hongsuk KIM, Seoul (KR)

(21) Appl. No.: 18/715,349

(22) PCT Filed: Jan. 25, 2024
(86) PCT No.: PCT/KR2024/001194

§ 371 Date: May 31, 2024

Related U.S. Application Data
(60) Provisional application No. 63/444,568, filed on Feb. 10, 2023.

(51) Int. Cl. H04W 36/00; H04W 36/24; H04W 74/0833

(52) U.S. Cl. CPC H04W 36/0079; H04W 36/0077; H04W 36/00835; H04W 36/249; H04W 74/0833

(57) ABSTRACT

The present disclosure relates to selection of mobility timer value in wireless communications. According to an embodiment of the present disclosure, a method performed by a user equipment (UE) configured to operate in a wireless communication system comprises: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

### CROSS-REFERENCE TO RELATED APPLICATIONS

This application is the National Stage filing under 35 U.S.C. 371 of International Application No. PCT/KR2024/001194, filed on Jan. 25, 2024, which claims the benefit of U.S. Patent Application No. 63/444,568 filed on Feb. 10, 2023, which is all hereby incorporated by reference herein in its entirety.

### TECHNICAL FIELD

The present disclosure is related to selection of mobility timer value in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, when initiating a mobility to a target cell, a user equipment (UE) may start a timer (e.g., T304 timer), and perform the mobility to the target cell while the timer is running. When a mobility timer value of the timer is too small, the mobility failure may be detected too early. On the other hand, when the mobility timer value is too large, the mobility failure may be detected too late. Therefore, appropriate mobility timer value is required.

### SUMMARY

An aspect of the present disclosure is to provide method and apparatus for selection of mobility timer value in a wireless communication system.

According to an embodiment of the present disclosure, a method performed by a user equipment (UE) configured to operate in a wireless communication system comprises: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a message comprising a configuration for a candidate cell for a cell switch, and a plurality of timer values of a timer for detecting a cell switch failure, wherein each of the plurality of timer values is related to a corresponding cell switch type; and transmitting, to the UE, a cell switch command for the candidate cell, wherein the cell switch to the candidate cell is initiated based on the cell switch command, wherein the timer with a timer value among the plurality of timer values is started upon the UE initiating the cell switch, and the timer value is related to a cell switch type of the cell switch to be performed, and wherein the cell switch to the candidate cell is performed while the timer is running.

According to an embodiment of the present disclosure, a method performed by a network node configured to operate in a wireless communication system comprises: transmitting, to a user equipment (UE), a message comprising a configuration for a candidate cell for a cell switch, and a plurality of timer values of a timer for detecting a cell switch failure, wherein each of the plurality of timer values is related to a corresponding cell switch type; and transmitting, to the UE, a cell switch command for the candidate cell, wherein the cell switch to the candidate cell is initiated based on the cell switch command, wherein the timer with a timer value among the plurality of timer values is started upon the UE initiating the cell switch, and the timer value is related to a cell switch type of the cell switch to be performed, and wherein the cell switch to the candidate cell is performed while the timer is running.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

According to an embodiment of the present disclosure, a non-transitory computer readable medium (CRM) has stored thereon a program code implementing instructions that, based on being executed by at least one processor, perform operations comprising: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

The present disclosure may have various advantageous effects.

For example, according to the present disclosure, during the cell switch procedure, the UE may apply an appropriate failure detection timer value based on whether a RA procedure is performed or not. Therefore, LTM failure early/late detection problem can be resolved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a signaling procedure for LTM according to an embodiment of the present disclosure.

FIG. 9 shows an example of a CBRA procedure according to an embodiment of the present disclosure.

FIG. 10 shows an example of a CFRA procedure according to an embodiment of the present disclosure.

FIG. 11 shows an example of a method performed by a UE according to an embodiment of the present disclosure.

FIG. 12 shows an example of a signal flow between a UE and a network node according to an embodiment of the present disclosure.

FIG. 13 shows an example of a method for indicating a physical channel configuration in LTM according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

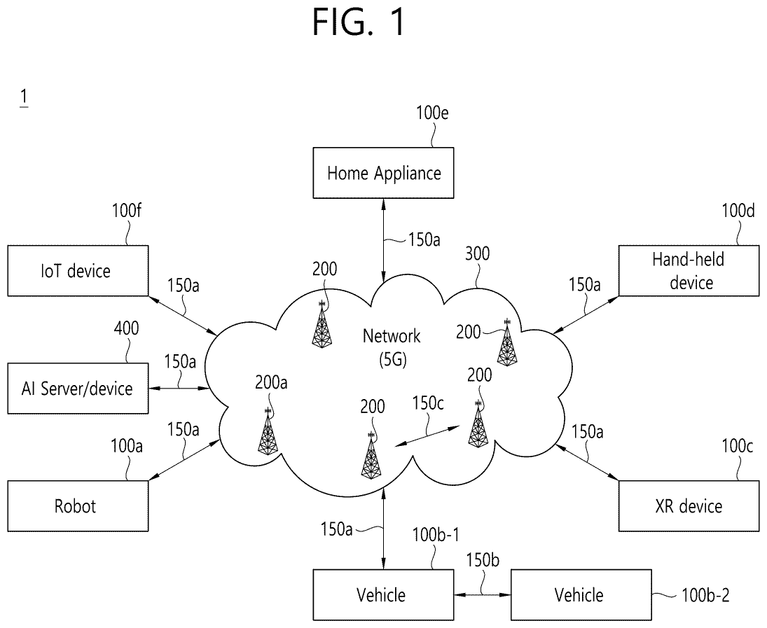

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

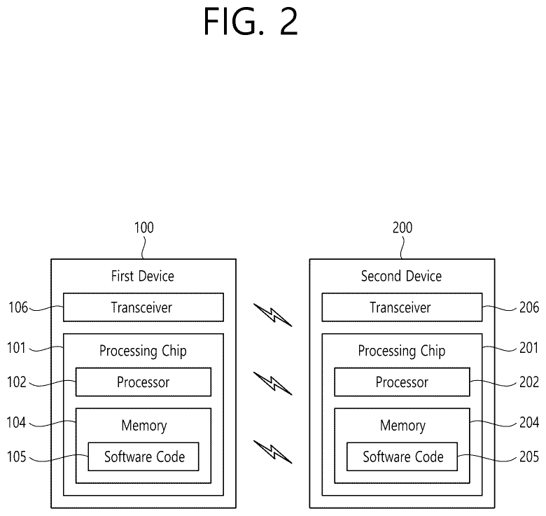

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

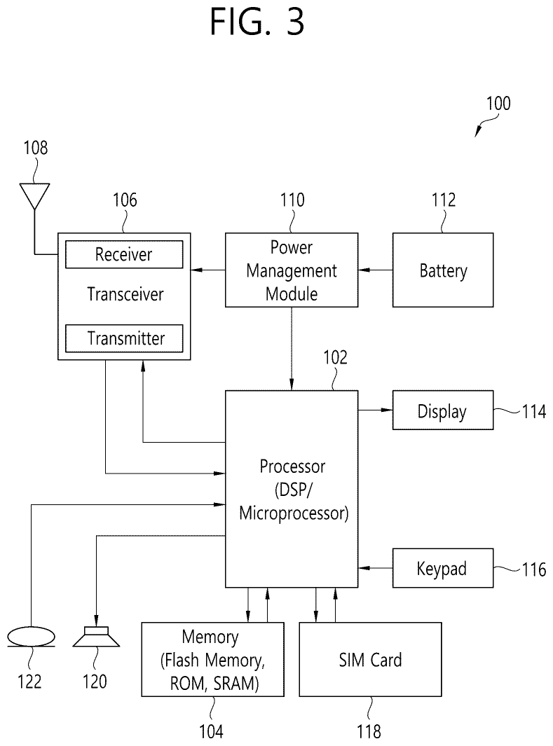

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

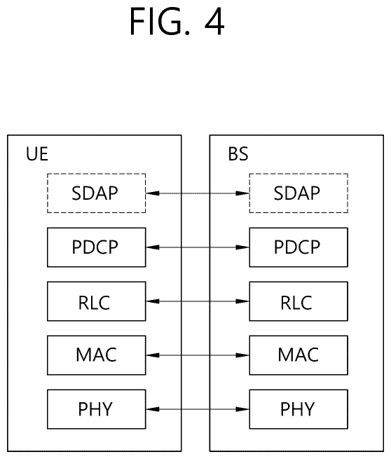

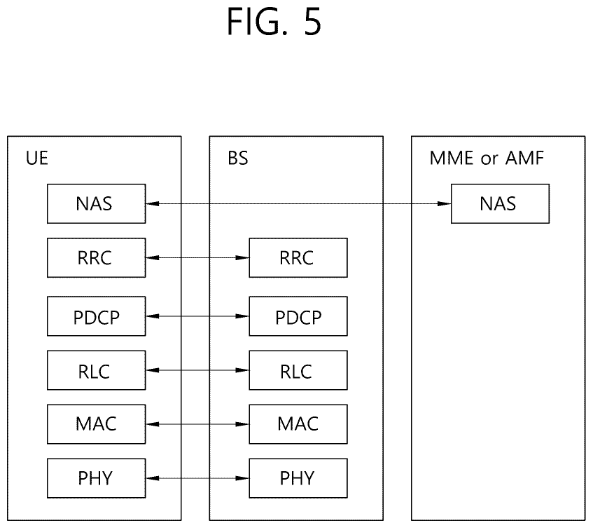

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

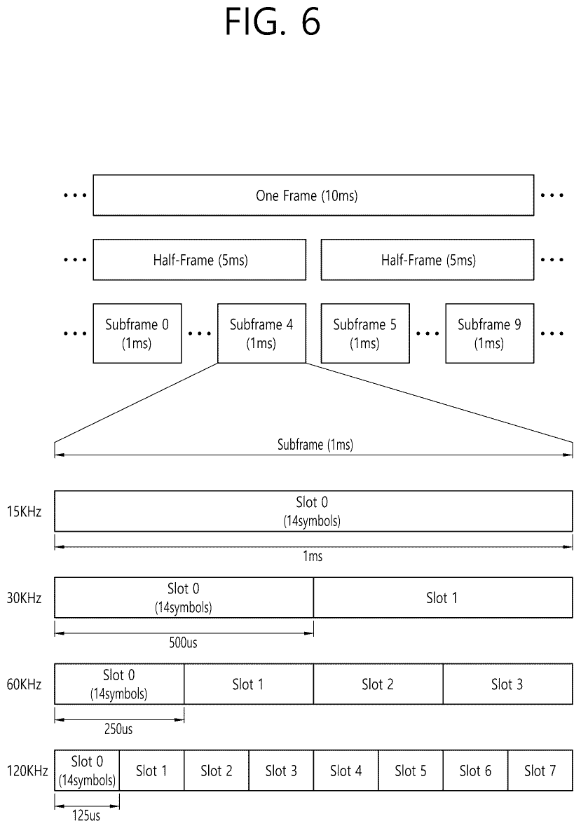

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{μ}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{μ}*15 KHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{μ}*15 KHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is Ims, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 KHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: N_{PRB}=N_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

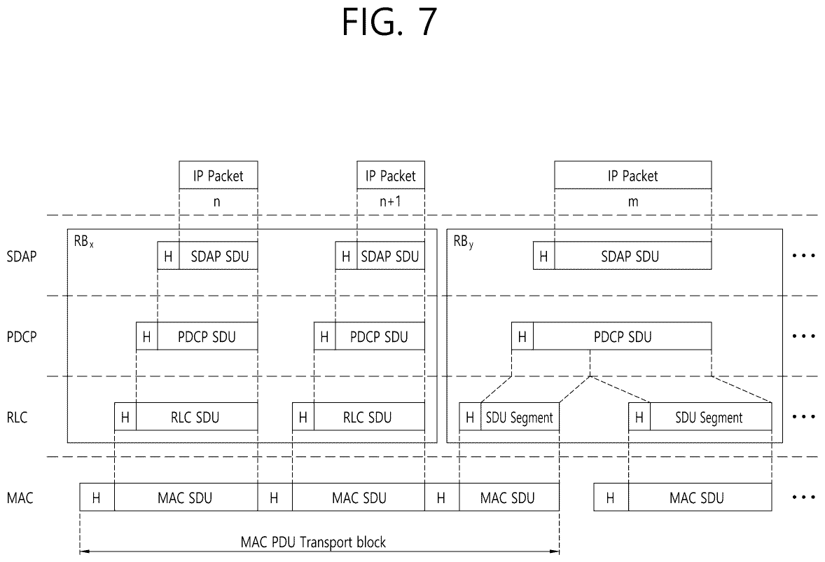

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding mobility are described.

The mobility may comprise PCell change, PSCell change (or, secondary node (SN) change), and/or PSCell addition (or, SN addition).

There may be at least two types of mobility: network-controlled mobility (or, legacy mobility) and UE-based mobility (or, conditional mobility).

The network-controlled mobility (or, legacy mobility) is a mobility where the network determines a target cell for mobility, and configures UE with the target cell. The network may transmit, to the UE, an RRCReconfiguration message comprising a configuration for the target cell. The UE may execute a mobility to the target cell/apply the configuration for the target cell, upon receiving the cell configuration for the target cell.

The UE-based mobility (or, conditional mobility) is a mobility where the network configures the UE with a plurality of candidate cells, and the UE determines a target cell which satisfies a mobility execution condition among the plurality of candidate cells. The network may transmit, to the UE, an RRCReconfiguration message comprising ConditionalReconfiguration information element (IE), which comprises a list of conditional reconfigurations for the plurality of candidate cells. A conditional reconfiguration for a candidate cell may comprise an identifier of the conditional reconfiguration, a mobility execution condition for the candidate cell, and a configuration for the candidate cell. The UE may evaluate the mobility execution conditions for the plurality of candidate cells, and when a mobility execution condition for a candidate cell is satisfied, the UE may consider the candidate cell as a target cell, and execute a mobility to the target cell/apply the configuration for the target cell.

In the present disclosure, the term “handover (HO)” may mean PCell change, or may be a broad concept that includes not only PCell change but also PSCell change/addition.

In the present disclosure, the terms “handover”, “mobility” and “cell switch” can be used interchangeably.

In the present disclosure, the description regarding handover can also be applied to other mobility procedures (e.g., PSCell change/addition).

Hereinafter, L1/L2-triggered mobility (LTM) is described.

LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling.

An LTM candidate cell may be configured via a RRCReconfiguration message for candidate target cell, and/or a CellGroupConfig IE for each candidate target cell.

The following principles may apply to LTM:
Candidate cell configuration can be provided as delta configurations on top of a reference configuration. The reference configuration is managed separately, and UE stores the reference configuration as a separate configuration.
User plane is continued whenever possible (e.g., intra-distributed unit, DU), without reset, with the target to avoid data loss and the additional delay of data recovery.
Security is not updated in LTM.
Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios may be supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.
Dual connectivity scenario, at least for the PSCell change without MN involvement case, i.e. intra-SN.

Inter-cell beam management is also supported, but is not considered as a prerequisite for using LTM.

The design for intra-DU and inter-DU L1/L2-based mobility should share as much commonality as reasonable.

In some implementations, validity/compliance check of candidate cell configuration are performed upon reception of the candidate cells configuration.

Cell switch trigger information is conveyed in a MAC CE, which contains at least a candidate configuration index. Cell-specific, radio bearer, and measurement configurations can be part of an LTM candidate cell configuration.

In some implementations, the MAC CE can indicate TCI state(s) (or other beam information) to be activated for the target cell(s)

In some implementations, it is possible to perform SCell activation/deactivation (amongst SCells associated with the candidate configuration) simultaneously with the LTM triggering MAC CE.

UE may perform contention-based random access (CBRA) or contention-free random access (CFRA) at cell switch. UE may also skip random access procedure if UE doesn't need to acquire timing advance (TA) for the target cell during cell switch. RACH resources for CFRA are provided in RRC configuration.

In some implementations, the CFRA resources can be provide via MAC CE.

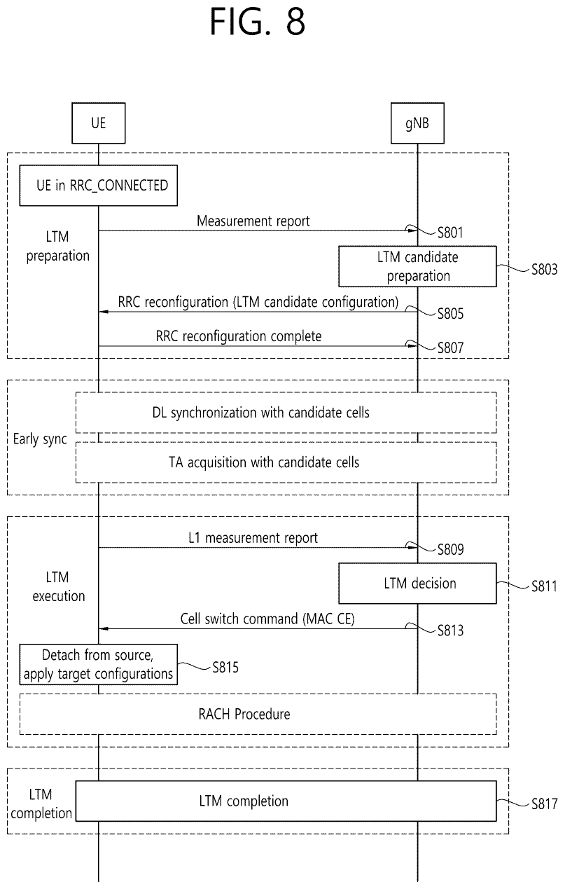

The overall procedure for LTM is shown in FIG. 8 below. Subsequent LTM is done by repeating the early synchronization, LTM execution, and LTM completion steps without releasing other candidates after each LTM completion.

FIG. 8 shows an example of a signaling procedure for LTM according to an embodiment of the present disclosure.

Referring to FIG. 8, in step S801, UE may send a MeasurementReport message to gNB.

In step S803, the gNB may decide to use LTM and initiate LTM candidate preparation.

In step S805, the gNB may transmit an RRCReconfiguration message to the UE including the configuration of one or multiple LTM candidate target cells.

In step S807, the UE may store the configuration of LTM candidate target cell(s) and transmit a RRCReconfigurationComplete message to the gNB.

In some implementations, the UE may optionally perform early synchronization. In this case, the UE may perform DL synchronization and/or TA acquisition with candidate target cell(s) before receiving the LTM cell switch command.

For example, DL synchronization for candidate cell(s) before cell switch command may be supported, at least based on SSB.

For example, TA acquisition of candidate cell(s) before LTM cell switch command may be supported, at least based on PDCCH ordered RACH, where the PDCCH order is only triggered by source cell.

In step S809, UE may perform L1 measurements on the configured LTM candidate target cell(s), and transmit lower-layer measurement reports to the gNB. The lower-layer measurement reports may be carried on L1 or MAC.

In step S811, the gNB may decide to execute LTM cell switch to a target cell.

In step S813, the gNB may transmit a MAC CE triggering LTM cell switch by including the candidate configuration index of the target cell. The UE may switch to the configuration of the LTM candidate target cell.

In step S815, UE may detach from the source cell, and apply the target cell configuration(s). If TA is not available, the UE may perform a random access procedure (or, RACH procedure) towards the target cell.

In step S817, the UE may indicate successful completion of the LTM cell switch towards the target cell.

In some implementations, an uplink signal or message after the UE has switched to the target cell may be used to indicate successful completion of the LTM cell switch.

In FIG. 8, the RACH procedure can be skipped (i.e., UE may perform a RACH-less mobility to the target cell), when a RACH-skip condition is satisfied. The RACH-skip condition may comprise one or more of the following conditions:
TA information of the target cell is available to the UE and/or TA of the target cell is valid;
beam indication of the target cell is available to the UE and/or no beam failure is detected on the target cell; or
uplink (UL) grant for transmitting the uplink signal indicating successful completion of the LTM cell switch is available to the UE.

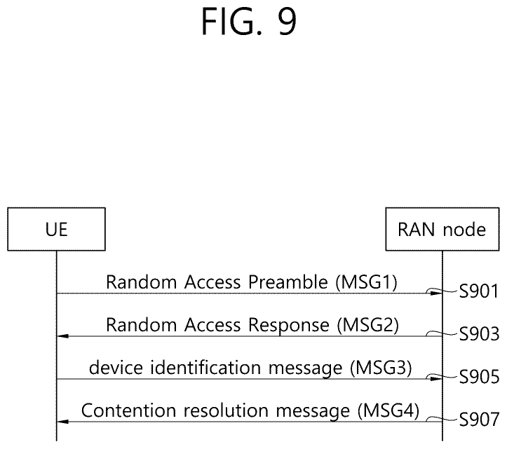

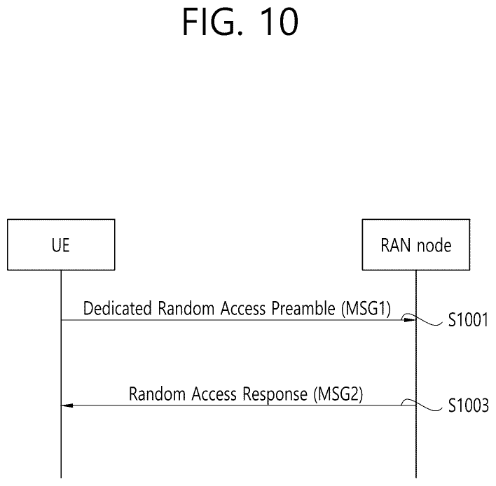

When performing the random access procedure/RACH procedure: i) the UE may perform a contention-free random access (CFRA) if CFRA resources/dedicated RACH configuration is available to the UE; and ii) the UE may perform a contention-based random access (CBRA) if CFRA resources/dedicated RACH configuration is not available to the UE. Detailed CBRA procedure and CFRA procedure are shown in FIGS. 9 and 10, respectively.

FIG. 9 shows an example of a CBRA procedure according to an embodiment of the present disclosure.

Referring to FIG. 9, in step S901, the UE may transmit a random access preamble in uplink, to a RAN node. The UE may transmit a message 1 (MSG1) comprising the random access preamble to the RAN node. The random access preamble may be associated with a random access-radio resource temporary identifier (RA-RNTI). The random access preamble may be selected based on the selected RACH resources, and transmitted through a time/frequency resources identified by the selected RACH resources.

In step S903, the UE may receive a random access response (RAR) generated by MAC on downlink-shared channel (DL-SCH), from the RAN node. The UE may receive a message 2 (MSG2) comprising the RAR from the RAN node. The UE may monitor a PDCCH with the corresponding RA-RNTI within a RAR-window. When the PDCCH with the corresponding RA-RNTI is detected within the RAR-window, the UE may read the corresponding downlink control information (DCI) scheduling a RAR PDSCH, and receive the RAR in the PDSCH. The RAR may comprise timing advance (TA) information for time-synchronized in uplink, UL grant, and/or temporary cell-RNTI (TC-RNTI).

In step S905, the UE may transmit a device identification message to the RAN node. The UE may transmit a message 3 (MSG3) comprising the device identification message via PUSCH corresponding to the UL grant in the RAR. The device identification message may comprise the TC-RNTI.

In step S907, the UE may receive a contention resolution message from the RAN node. The UE may receive a message 4 (MSG4) comprising the contention resolution message. The UE may monitor a PDCCH with the TC-RNTI. When the PDCCH with the TC-RNTI is detected, the UE may read the corresponding DCI scheduling a PDSCH, receive the contention resolution message in the PDSCH, and set C-RNTI as the TC-RNTI.

FIG. 10 shows an example of a CFRA procedure according to an embodiment of the present disclosure.

Referring to FIG. 10, in step S1001, the UE may transmit a dedicated random access preamble in uplink, to a RAN node. The UE may transmit a message 1 (MSG1) comprising the dedicated random access preamble to the RAN node. The dedicated random access preamble may be associated with a random access-radio resource temporary identifier (RA-RNTI). The dedicated random access preamble may be selected based on the CFRA resources/dedicated RACH configuration, and transmitted through a time/frequency resources identified by the CFRA resources/dedicated RACH configuration.

In step S1003, the UE may receive a random access response (RAR) generated by MAC on downlink-shared channel (DL-SCH), from the RAN node. The UE may receive a message 2 (MSG2) comprising the RAR from the RAN node. The UE may monitor a PDCCH with the corresponding RA-RNTI within a RAR-window. When the PDCCH with the corresponding RA-RNTI is detected within the RAR-window, the UE may read the corresponding downlink control information (DCI) scheduling a RAR PDSCH, and receive the RAR in the PDSCH. The RAR may comprise timing advance (TA) information for time-synchronized in uplink, UL grant, and/or cell-RNTI (C-RNTI). Upon receiving the RAR from the RAN node, the UE may end the CFRA procedure.

Meanwhile, L1/L2 triggered mobility (LTM) is introduced in order to reduce latency, overhead and interruption time. For LTM, network may provide UE in advance with a configuration of a candidate cell (i.e., preconfiguration of candidate cells for LTM). Then, the UE may perform L1 measurement of the candidate cell and perform an L1 measurement reporting (i.e., report the measurement results for the candidate cell to the network). The network may determine that the UE executes LTM to the candidate cell based on the L1 measurement reporting. The network may transmit, to the UE, an LTM command (or, cell switch command) via L1/L2 signaling to trigger the UE to execute the LTM toward the candidate cell. Upon receiving the LTM command, the UE may initiate the cell switch procedure (i.e., LTM execution to the candidate cell), where the cell switch procedure is supervised by a timer. A detailed cell switch procedure supervised by a timer may be as follows: i) the timer starts when the UE initiates the LTM execution procedure; ii) the timer stops when the LTM execution is successfully completed; and iii) the UE detects the failure of LTM execution when the timer expires.

The LTM can be executed in the following two types: i) random access channel (RACH)-based LTM execution, where the random access (RA) procedure is performed during the LTM execution; and ii) RACH-less LTM execution, where the RA procedure is not performed during the LTM execution. RACH-based LTM execution can be sub-divided into two types: contention-based random access (CBRA) and contention free random access (CFRA).

If the network configures the UE with an improper timer value for the LTM execution procedure, then the UE may detect an LTM failure too early or too late (i.e., LTM failure early/late detection problem). The LTM failure early detection problem may incur a false failure detection, while the LTM failure late detection may increase the mobility interruption time. When RACH-based LTM execution is performed if the timer value assuming RACH-less LTM execution (i.e., small timer value) is configured, the LTM failure may be detected too early because the timer values is too small to wait for RA completion even though a normal RACH procedure is in progress. When RACH-less LTM execution is performed with the timer value assuming RACH-based LTM execution (i.e., large timer value), the LTM failure may be detected too late because the timer is still running even if the LTM execution is already failed.

In the present disclosure, ‘cell switch’ and ‘LTM execution’ can be used interchangeably.

In the present disclosure, ‘cell switch failure’ and ‘LTM failure’ can be used interchangeably.

In the present disclosure, ‘cell switch command’ and ‘LTM command’ can be used interchangeably.

In the present disclosure, ‘LTM timer’ and ‘failure detection timer’ can be used interchangeably.

In the present disclosure, ‘mobility execution type’, ‘cell switch type’, ‘type of cell switch’ and ‘LTM execution type’ can be used interchangeably.

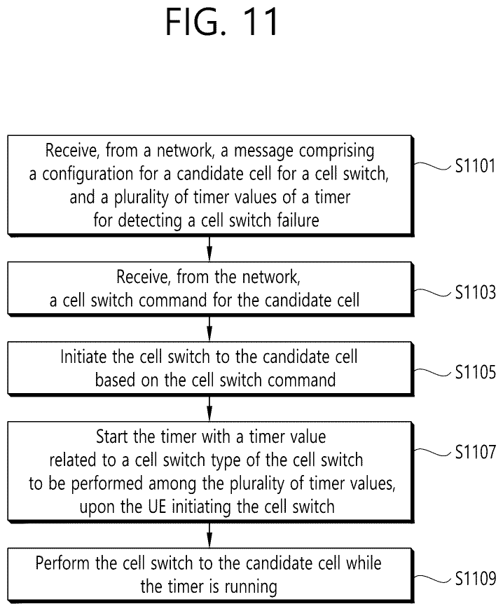

FIG. 11 shows an example of a method performed by a UE according to an embodiment of the present disclosure. The method may also be performed by a wireless device.

Referring to FIG. 11, in step S1101, the UE may receive, from a network, a message comprising a configuration for a candidate cell for a cell switch, and a plurality of timer values of a timer for detecting a cell switch failure. Each of the plurality of timer values may be related to a corresponding cell switch type.

In step S1103, the UE may receive, from the network, a cell switch command for the candidate cell.

In step S1105, the UE may initiate the cell switch to the candidate cell based on the cell switch command.

In step S1107, the UE may start the timer with a timer value related to a cell switch type of the cell switch to be performed among the plurality of timer values, upon the UE initiating the cell switch.

In step S1109, the UE may perform the cell switch to the candidate cell while the timer is running.

According to various embodiments, the message may comprise a plurality of configurations for candidate cells for the cell switch including the configuration for the candidate cell. Each of the plurality of configurations may be related to a corresponding candidate cell, and comprises a candidate configuration index of a configuration for the corresponding candidate cell. The cell switch command may comprise a candidate configuration index of the configuration for the candidate cell. The UE may identify, among the plurality of configurations for the candidate cells, the configuration for the candidate cell with matching candidate configuration index in the cell switch command. The UE may apply the identified configuration for the candidate cell, for performing the cell switch to the candidate cell.

According to various embodiments, the plurality of configurations for the candidate cells may be received via a radio resource control (RRC) signaling. The cell switch command may be received via a media access control (MAC) control element (CE) signaling.

According to various embodiments, the UE may obtain a list of candidate cell configurations for failure recovery among the plurality of configurations for the candidate cells for the cell switch. The UE may detect the cell switch failure upon an expiry of the timer. Based on a candidate cell configuration in the list of candidate cell configurations, the UE may perform a failure recovery procedure to a candidate cell related to the candidate cell configuration.

According to various embodiments, the list of candidate cell configurations may be included in at least one of the message, the configuration for the candidate cell, or the cell switch command.

According to various embodiments, the configuration for the candidate cell may comprise the plurality of timer values of the timer for detecting the cell switch failure.

According to various embodiments, the cell switch type comprises at least one of a random access channel (RACH)-less cell switch or a RACH-based cell switch. The plurality of timer values may comprise at least one of: a first timer value related to the RACH-less cell switch; or a second timer value related to the RACH-based cell switch. The RACH-less cell switch may comprise skipping a random access to the candidate cell while the timer with the first timer value is running. The RACH-based cell switch may comprise performing a contention-free random access (CFRA) or a contention-based random access (CBRA) to the candidate cell while the timer with the second timer value is running.

According to various embodiments, the cell switch type may comprise at least one of a random access channel (RACH)-less cell switch, a contention-free random access (CFRA)-based cell switch, or a contention-based random access (CBRA)-based cell switch. The plurality of timer values may comprise at least one of: a first timer value related to the RACH-less cell switch; a second timer value related to the CFRA-based cell switch; or a third timer value related to the CBRA-based cell switch. The RACH-less cell switch may comprise skipping a random access to the candidate cell while the timer with the first timer value is running. The CFRA-based cell switch may comprise performing a CFRA to the candidate cell while the timer with the second timer value is running. The CBRA-based cell switch may comprise performing a CBRA to the candidate cell while the timer with the third timer value is running.

According to various embodiments, the UE may determine the cell switch type based on at least one of a random access channel (RACH)-skip condition or whether contention-free random access (CFRA) resources are available to the UE. The UE may determine the timer value related to the determined cell switch type. The RACH-skip condition may comprise at least one of: a condition that timing advance (TA) information for the candidate cell and a beam indication of the candidate cell are included in the cell switch command; a condition that a TA for the candidate cell is valid; or a condition that no beam failure is detected on the candidate cell.

According to various embodiments, the cell switch type may comprise at least one of a random access channel (RACH)-less cell switch or a RACH-based cell switch. The cell switch type may be determined as the RACH-less cell switch based on the RACH-skip condition being satisfied. The cell switch type may be determined as the RACH-based cell switch based on the RACH-skip condition being not satisfied.

According to various embodiments, the cell switch type may comprise at least one of a random access channel (RACH)-less cell switch, a contention-free random access (CFRA)-based cell switch, or a contention-based random access (CBRA)-based cell switch. The cell switch type may be determined as the RACH-less cell switch based on the RACH-skip condition being satisfied. The cell switch type may be determined as the CFRA-based cell switch based on the RACH-skip condition being not satisfied and the CFRA resources being available to the UE. The cell switch type may be determined as the CBRA-based cell switch based on the RACH-skip condition being not satisfied and the CFRA resources being not available to the UE.

According to various embodiments, the cell switch may comprise a layer 1 (L1)/layer 2 (L2)—triggered mobility (LTM). The cell switch command may comprise an LTM command.

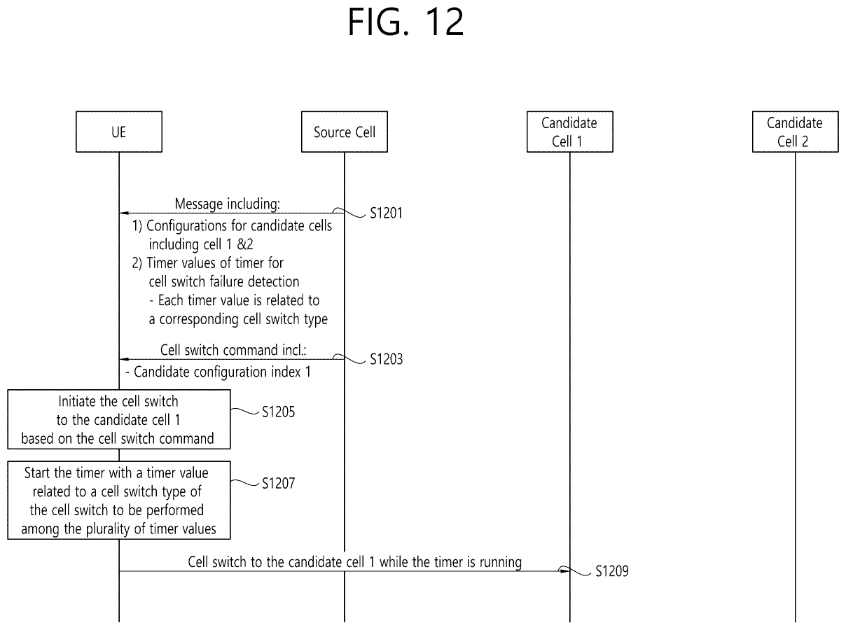

FIG. 12 shows an example of a signal flow between a UE and a network node according to an embodiment of the present disclosure. The network node may comprise a base station (BS), and may be related to a source cell in cell switch.

Referring to FIG. 12, in step S1201, the network node may transmit, to the UE, a message comprising configurations for candidate cells including candidate cell 1 and candidate cell 2, and timer values of a timer for cell switch failure detection. Each timer value may be related to a corresponding cell switch type.

In step S1203, the network node may transmit, to the UE, a cell switch command comprising a candidate configuration index 1 for the candidate cell 1.

In step S1205, the UE may initiate the cell switch to the candidate cell 1 based on the cell switch command.

In step S1207, the UE may start the timer with a timer value related to a cell switch type of the cell switch to be performed among the plurality of timer values, upon the UE initiating the cell switch.

In step S1209, the UE may perform the cell switch to the candidate cell 1 while the timer is running.

According to implementations of the present disclosure, the network (NW) may configure two or more LTM timer values with the UE before or by LTM command transmission to the UE, where each timer value corresponds to an LTM execution type. An LTM execution type may be RACH-based (i.e., CBRA or CFRA) LTM execution, or RACH-less LTM execution. Upon receiving an LTM command, the UE may check one or more conditions to decide the LTM execution type and then initiate the LTM execution procedure with starting the failure detection timer (i.e., LTM timer) of which value corresponds to the LTM execution type. That is, for the timer value, the configured value corresponding to the LTM execution type of the LTM execution procedure to be performed is applied. If the cell switch procedure does not succeed until the failure detection timer expires, the UE may perform a failure recovery procedure.

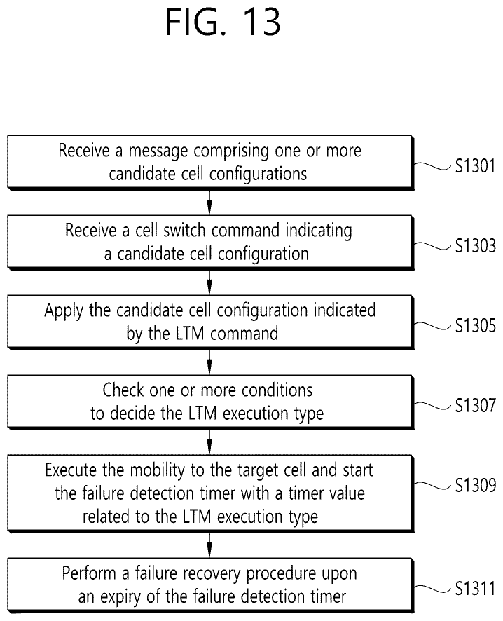

FIG. 13 shows an example of a method for indicating a physical channel configuration in LTM according to an embodiment of the present disclosure. The method may be performed by a UE and/or a wireless device.

Referring to FIG. 13, in step S1301, UE may receive a message (i.e., RRC message/configuration such as RRC reconfiguration message) comprising one or more candidate cell configurations (i.e., one or more configurations for candidate cells). That is, one or more candidate serving cells may be configured. The (pre) configuration of a candidate cell may comprise at least one of: a part that the UE applies directly at the time of LTM execution; or another part that the UE selectively applies based on the indications included in the LTM command upon LTM execution.

A candidate cell configuration (or, a configuration for a candidate cell) may comprise at least one of:
configuration(s) for a special cell, e.g., servingCellConfigCommon, servingCellConfig, reconfiguration WithSync, RLF relevant configuration;
configuration(s) for SCells, e.g., servingCellConfigCommon, servingCellConfig, smtc, DRX configuration; or
MAC/RLC related configurations.

The candidate cell configuration may comprise a set of BWP configurations. For each BWP configuration, a flag may be included to indicate whether the UE firstly applies the corresponding BWP configuration upon LTM execution or not. Sets of resource configurations such as configurations for a physical channel (i.e., sets of physical channel configurations) can be included in each BWP configuration. For example, each BWP configuration may comprise at least one of a set of PUCCH configurations, a set of PUSCH configurations, a set of PDCCH configurations, a set of PDSCH configurations, or a set of PRACH configurations. For each physical channel configuration in a set, a flag may be included to indicate whether the UE firstly applies the corresponding physical channel configuration upon LTM execution or not.

According to various embodiments, there may be one or more timer values and/or one or more timer configurations. Each timer configuration (i.e., a configuration for a timer value) may comprise an identifier or index of the corresponding timer configuration, and the corresponding timer value. The timer value may be used for a failure detection timer during cell switch procedure.

A timer value may correspond to which type of mobility is to be performed/executed (i.e., mobility execution type) during cell switch procedure. For example, a mobility execution type can be divided into the following two types: i) RACH-based execution (i.e., RA procedure is performed during cell switch procedure); and/or ii) RACH-less execution (i.e., RA procedure is not performed during cell switch procedure). For another example, a mobility execution type can be divided into the following three types: i) CBRA-based execution (i.e., CBRA procedure is performed during cell switch procedure); ii) CFRA-based execution (i.e., CFRA procedure is performed during cell switch procedure; or iii) RACH-less execution (i.e., RA (i.e., CBRA or CFRA) procedure is not performed during cell switch procedure).

In some implementations, the one or more timer values and/or one or more timer configurations may be included in the message comprising the one or more candidate cell configurations (i.e., one or more configurations for candidate cells). In this case, the one or more timer values and/or one or more timer configurations may be common for the one or more candidate cell configurations/candidate cells.

In some implementations, the one or more timer values and/or one or more timer configurations may be included in each candidate cell configuration (i.e., a configuration for a candidate cell). In this case, the one or more timer values and/or one or more timer configurations may be dedicated for the corresponding candidate cell configuration/candidate cell.

According to various embodiments, there may be a list of cells to be used for cell switch failure recovery. The list may contain the indices of candidate cell configurations to be used for cell switch failure recovery. For example, upon cell switch failure detection, a cell out of the list can be considered as the new target cell for cell switch.

In some implementations, the list of cells to be used for cell switch failure recovery may be included in the message comprising the one or more candidate cell configurations (i.e., one or more configurations for candidate cells). In this case, the list of cells to be used for cell switch failure recovery may be common for the one or more candidate cell configurations/candidate cells.

In some implementations, the list of cells to be used for cell switch failure recovery may be included in each candidate cell configuration (i.e., a configuration for a candidate cell). In this case, the list of cells to be used for cell switch failure recovery may be dedicated for the corresponding candidate cell configuration/candidate cell.

In step S1303, UE may receive a cell switch command (i.e., LTM command) indicating a candidate cell configuration (i.e., configuration of a candidate cell). The cell switch command can be transmitted via L1/L2/L3 signalling. The cell switch command may be related to either network controlled serving cell change or UE autonomous serving cell change (e.g., conditional mobility).

The cell switch command may comprise at least one of:
target cell information: if a target cell is one of the preconfigured candidate serving cells for the UE, the target cell information may be an identifier of the candidate serving cell/candidate cell configuration indicated by the LTM command. Else (i.e., target cell is not one of the preconfigured candidate serving cells for the UE), the target cell information may be a configuration for the target cell/candidate cell configuration (e.g., RRCReconfiguration including reconfiguration WithSync).
ConditionalReconfiguration, in case of conditional mobility.
indicator indicating that the source cell is changed to a candidate serving cell: For example, the indicator may be a 1-bit indication in DCI or MAC CE. For example, the LTM command via L1/L2 signalling may implicitly indicate that the source cell is changed to a candidate serving cell. For example, the target cell may be included in a list, where the list may indicate that the source cell is changed to a candidate serving cell. For example, the indicator may be an explicit RRC information element (IE).
Cell switch parameters (i.e., configurations for the UE to apply upon LTM execution): For example, the cell switch parameters may comprise a physical channel configuration index indicating a PRACH configuration, a PUCCH configuration, a PUSCH configuration, a PDCCH configuration, and/or a PDSCH configuration. The cell switch parameters may comprise DL/UL BWP index, SCell state, TA information, TCI state, indications for L2 operations (e.g., PDCP recovery/RLC re-establishment/MAC (full or partial) reset), SSB/CSI-RS, and/or indication whether the UE performs random access or not upon LTM execution.

The cell switch command may comprise timer values to be used for a failure detection timer during cell switch procedure. The cell switch command may include one or more identifiers (or indices) indicating the configurations for timer values. Or, the cell switch command may include one or more timer values to be used for a failure detection timer during cell switch procedure.

A timer value may correspond to which type of mobility to executed/performed (i.e., mobility execution type) during cell switch procedure. For example, the mobility execution type can be divided into the following two types: RACH-based execution (i.e., RA procedure is performed during cell switch procedure); and ii) RACH-less execution (i.e., RA procedure is not performed during cell switch procedure). For another example, the mobility execution type can be divided into the following three types: i) CBRA-based execution (i.e., CBRA procedure is performed during cell switch procedure); ii) CFRA-based execution (i.e., CFRA procedure is performed during cell switch procedure); and iii) RACH-less execution (i.e., RA (i.e. CBRA or CFRA) procedure is not performed during cell switch procedure).

The cell switch command may comprise a list of cells to be used for cell switch failure recovery. The list may contain the indices of candidate cell configurations to be used for cell switch failure recovery. The cell switch command may need to include the cell switch parameters of the cells in the list. Upon cell switch failure detection, one cell out of the list can be considered as the new target cell for cell switch.

In step S1305, the UE may apply the candidate cell configuration indicated by the LTM command.

For example, if the received LTM command has ConditionalReconfiguration (i.e., in case of conditional mobility), the UE may apply the stored configuration (e.g., condRRCReconfig) of the cell for which an execution condition is satisfied

For example, if the received LTM command does not have ConditionalReconfiguration (i.e., in case of legacy mobility), the UE may apply the configuration of stored candidate cell/candidate cell configuration, which is indicated in the LTM command. If the LTM command includes the cell switch parameters/configuration for the UE to apply upon LTM execution, the UE may selectively apply the preconfiguration with the indications by the LTM command. For example, if the preconfiguration has first and second PRACH configurations for the BWP and if the LTM command indicates the first PRACH configuration, then for the PRACH configuration the UE applies the first PRACH configuration, not the second PRACH configuration. Else if the LTM command does not include the configuration for the UE to apply upon LTM execution, the UE may directly apply the preconfiguration of the candidate cell.

In step S1307, the UE may check one or more conditions to decide the LTM execution type. For example, the LTM execution type may determined as follows:
If TA information and/or beam indication of the candidate cell is included in the cell switch command, the LTM execution type may be determined as RACH-less LTM execution.
Else if TA of the candidate cell is valid and there is no beam failure on the candidate cell (provided that TA of the candidate cell has been maintained based on TA adjustment procedure and that beam failure detection procedure has been performed/monitored for the candidate cell), the LTM execution type may be determined as RACH-less LTM execution.
Else (i.e., if TA information and beam indication of the candidate cell are not included in the cell switch command, and if TA of the candidate cell has not been maintained based on TA adjustment procedure or beam failure detection procedure has not been performed/monitored for the candidate cell or beam failure is detected on the candidate cell), the LTM execution type may be determined as RACH-based LTM execution. If CFRA resource is indicated in either the cell switch command or the configuration of the candidate cell, the LTM execution type may be determined as CFRA-based LTM execution. Else (i.e., CFRA resource is not indicated), the LTM execution type may be determined as CBRA-based LTM execution.

In step S1309, the UE may execute the mobility by transmitting a UL signal to the candidate cell (i.e., the target cell) and/or starting the failure detection timer with a timer value related to the LTM execution type.

In some implementations, the UE may transmit the UL signal/message to the candidate cell via L1 signalling (e.g., PUCCH, PUSCH, PRACH). If the UE is configured by the (pre) configuration of the candidate cell with a dedicated PRACH configuration (i.e., CFRA-based LTM execution), the UE may transmit, to the candidate cell, the RA preamble based on the dedicated PRACH configuration of the (pre) configuration. Else if a dedicated PRACH configuration of the candidate cell is indicated to the UE by the LTM command (i.e., CFRA-based LTM execution), the UE may transmit, to the candidate cell, the RA preamble based on the dedicated PRACH configuration indicated by the LTM command. Else (i.e., the UE does not have the dedicated PRACH configuration), the UE may transmit, to the candidate cell, an RA preamble based on the common PRACH configuration of the (pre) configuration.

For example, the UE may transmit, to the candidate cell, a random access (RA) preamble in case of RACH-based LTM execution.

For example, the UE may transmit, to the candidate cell, scheduling request in case of RACH-less LTM execution.

In some implementations, the UE may transmit the UL signal to the candidate cell via L2 signalling (e.g., MAC CE). For example, the UE may transmit, to the candidate cell, an LTM Complete MAC CE indicating the UE arrival in case of RACH-less LTM execution.

In some implementations, the UE may transmit the UL signal to the candidate cell via L3 signalling (e.g., RRCReconfigurationComplete).

The first UL signal may be transmitted on the UL resource corresponding to the indicated physical channel configuration. For example, if the LTM command indicates a specific PRACH configuration, then the UE may transmit the RA preamble corresponding to the indicated PRACH configuration. For example, if the LTM command does not include the information of physical channel configuration and if the BWP configuration that the UE applies upon LTM execution has one physical channel configuration, then the UE may transmit the first UL signal on the UL resource corresponding to the physical channel configuration in the BWP configuration.

In some implementations:
If the mobility message (i.e., LTM command/cell switch command) is transmitted via L1/L2 signalling, the UE may keep the source resources and configurations, and/or perform TA maintenance and beam failure detection (BFD)/radio link monitoring (RLM) on the source cell/target cell.
If the mobility message includes the indicator indicating that the source cell is changed to a candidate serving cell, the UE may keep the source resources and configurations, and/or perform TA maintenance and BFD/RLM on the source cell/target cell
Else, the UE may release the source resources and configurations and/or stop DL/UL reception/transmission with the source cell.

If the list of cells to be used for cell switch failure recovery is configured, the UE may start to measure cells in the list. The measurement may be comprise at least one of L1 or L2 measurement.

The UE may start the failure detection timer with a timer value, upon initiating the execution of the mobility.

For example, the cell switch command may include single indication for setting timer value. In this case, the timer value for expiration may be set to the value indicated by the cell switch command.

For example, the cell switch command may include two indications for setting timer values, where one is for the RACH-less LTM execution and the other is for the RACH-based LTM execution. If the LTM execution type is determined as RACH-less LTM execution, the timer value for expiration may be set to the value corresponding to RACH-less LTM execution indicated by the cell switch command. Else if the LTM execution type is determined as RACH-based (i.e., CFRA or CBRA) LTM execution, the timer value for expiration may be set to the value corresponding to RACH-based LTM execution indicated by the cell switch command.

For example, the cell switch command may include three indications for setting timer value, where one is for the RACH-less LTM execution, another is for the CFRA-based LTM execution, and the other is for the CBRA-based LTM execution. If the LTM execution type is determined as RACH-less LTM execution, the timer value for expiration may be set to the value corresponding to RACH-less LTM execution indicated by the cell switch command. Else if the LTM execution type is determined as CFRA-based LTM execution, the timer value for expiration may be set to the value corresponding to CFRA-based LTM execution indicated by the cell switch command. Else if the LTM execution type is determined as CBRA-based LTM execution, the timer value for expiration may be set to the value corresponding to CBRA-based LTM execution indicated by the cell switch command.

For example, the cell switch command may not include any indication for setting timer value, and the configuration of the candidate cell may include two indications for setting timer values, where one is for the RACH-less LTM execution and the other is for the RACH-based LTM execution. In this case, the timer value for expiration is set to the value corresponding to RACH-less LTM execution indicated by the configuration of the candidate cell if the LTM execution type is determined as RACH-less LTM execution, and the timer value for expiration is set to the value corresponding to RACH-based LTM execution indicated by the configuration of the candidate cell if the LTM execution type is determined as RACH-based (i.e., CFRA or CBRA) LTM execution.

For example, the cell switch command may not include any indication for setting timer value, and the configuration of the candidate cell may include three indications for setting timer values, where one is for the RACH-less LTM execution, another is for the CFRA-based LTM execution, and the other is for the CBRA-based LTM execution. In this case, if the LTM execution type is determined as RACH-less LTM execution, the timer value for expiration may be set to the value corresponding to RACH-less LTM execution indicated by the configuration of the candidate cell. Else if the LTM execution type is determined as CFRA-based LTM execution, the timer value for expiration may be set to the value corresponding to CFRA-based LTM execution indicated by the configuration of the candidate cell. Else if the LTM execution type is determined as CBRA-based LTM execution, the timer value for expiration may be set to the value corresponding to CBRA-based LTM execution indicated by the configuration of the candidate cell.

In step S1311, the UE may perform a failure recovery procedure upon an expiry of the failure detection timer. That is, the UE may perform a failure recovery procedure if the cell switch procedure does not succeed until the failure detection timer expires (i.e., cell switch failure detection).

Upon cell switch failure detection, one cell out of the list of cells to be used for cell switch failure recovery given/configured by the candidate cell configuration and/or the cell switch command can be considered as the new target cell for cell switch.

For example, if the UE has the valid measurement results for cells in the list, the UE may consider the cell with best performance as the new target cell, and initiate the cell switch procedure by applying the configuration of the new target cell, which can be provided by the configuration for the candidate cell and/or the cell switch command.

For example, if the UE does not have the valid measurement results for cells in the list, the UE may consider one cell out of the list as the new target cell, and initiate the cell switch procedure by applying the configuration of the new target cell, which can be provided by the configuration for the candidate cell and/or the cell switch command.

If the list of cells to be used for cell switch failure recovery are not configured to the UE, the UE may initiate the RRC connection re-establishment procedure.

In the present disclosure, the UE may receive an RRC configuration for a candidate cell. The RRC configuration may include two or more timer values for a cell switch failure detection timer. The UE may receive a cell switch command to a target cell. The UE may perform a cell switch procedure to the target cell. The UE may start the cell switch failure detection timer. The value of the cell switch failure detection timer may be set to one of the configured timer values based on whether a random access to the target cell can be skipped or should be performed. The UE may stop the cell switch failure detection timer if the cell switch procedure succeeds. The UE may perform a failure recovery procedure if the cell switch failure detection timer expires.

The RRC configuration may include the list of cells to be used for failure recovery.

The value of the cell switch failure detection timer may be set to one of the two timer values based on whether a RA procedure is performed or not during the cell switch procedure, if the two timer values respectively for RACH-less cell switch and RACH-based cell switch were received/configured.

The value of the cell switch failure detection timer may be set to one of the three timer values based on whether a CBRA procedure is performed, a CFRA procedure is performed, or RA is skipped during the cell switch procedure, if the three timer values respectively for CBRA-based cell switch, CFRA-based cell switch, and RACH-less cell switch were received;

RACH-less cell switch may be performed if TA information and/or beam indication of the candidate cell are included in the cell switch command.

RACH-less cell switch may be performed if TA of the candidate has been maintained based on TA adjustment procedure and/or beam failure detection procedure has been performed/monitored for the candidate cell.

RACH-based cell switch may be performed if TA information and beam indication of the candidate cell are not included in the cell switch command, and if TA of the candidate cell has not been maintained based on TA adjustment procedure or beam failure detection procedure has not been performed/monitored for the candidate cell or beam failure is detected on the candidate cell.

CFRA-based cell switch may be performed if RACH-based cell switch is determined and if a dedicated RACH configuration is available.

CBRA-based cell switch may be performed if RACH-based cell switch is determined and if a dedicated RACH configuration is not available.

The cell switch command may include the list of cells to be used for failure recovery.

The candidate cell may become a new serving cell upon execution of the cell switch according to the cell switch command.

One cell out of the list may be considered as the new target cell for failure recovery if the list of cells to be used for failure recovery was received.

The cell switch procedure toward the new target cell may be initiated if the new target cell is selected from the list of cells to be used for failure recovery.

The RRC connection re-establishment procedure may be initiated if the list of cells to be used for failure recovery was not received.

Furthermore, the method in perspective of the UE described in the present disclosure (e.g., in FIG. 11) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

Furthermore, the method in perspective of the UE described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

Furthermore, the method in perspective of the UE described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network, a message comprising a configuration for a candidate cell for a cell switch, and a plurality of timer values of a timer for detecting a cell switch failure, wherein each of the plurality of timer values is related to a corresponding cell switch type; receiving, from the network, a cell switch command for the candidate cell; initiating the cell switch to the candidate cell based on the cell switch command, wherein the timer with a timer value among the plurality of timer values is started upon the UE initiating the cell switch, and the timer value is related to a cell switch type of the cell switch to be performed; and performing the cell switch to the candidate cell while the timer is running.

Furthermore, the method in perspective of a network node related to a source cell in cell switch described in the present disclosure (e.g., in FIG. 12) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a message comprising a configuration for a candidate cell for a cell switch, and a plurality of timer values of a timer for detecting a cell switch failure, wherein each of the plurality of timer values is related to a corresponding cell switch type; and transmitting, to the UE, a cell switch command for the candidate cell, wherein the cell switch to the candidate cell is initiated based on the cell switch command, wherein the timer with a timer value among the plurality of timer values is started upon the UE initiating the cell switch, and the timer value is related to a cell switch type of the cell switch to be performed, and wherein the cell switch to the candidate cell is performed while the timer is running.

The present disclosure may have various advantageous effects.

For example, according to the present disclosure, during the cell switch procedure, the UE may apply an appropriate failure detection timer value based on whether a RA procedure is performed or not. Therefore, LTM failure early/late detection problem can be resolved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) configured to operate in a wireless communication system, the method comprising:
receiving, from a network, a message comprising a configuration for a candidate cell for a cell switch, and a plurality of timer values of a timer for detecting a cell switch failure, wherein each of the plurality of timer values is related to a corresponding cell switch type;
receiving, from the network, a cell switch command for the candidate cell;
initiating the cell switch to the candidate cell based on the cell switch command, wherein the timer with a timer value among the plurality of timer values is started upon the UE initiating the cell switch, and the timer value is related to a cell switch type of the cell switch to be performed; and
performing the cell switch to the candidate cell while the timer is running.

2. The method of claim 1, wherein the message comprises a plurality of configurations for candidate cells for the cell switch including the configuration for the candidate cell,
wherein each of the plurality of configurations is related to a corresponding candidate cell, and comprises a candidate configuration index of a configuration for the corresponding candidate cell,
wherein the cell switch command comprises a candidate configuration index of the configuration for the candidate cell,
wherein the method further comprises identifying, among the plurality of configurations for the candidate cells, the configuration for the candidate cell with matching candidate configuration index in the cell switch command, and
wherein the performing of the cell switch comprises applying the identified configuration for the candidate cell.

3. The method of claim 2, wherein the plurality of configurations for the candidate cells are received via a radio resource control (RRC) signaling, and
wherein the cell switch command is received via a media access control (MAC) control element (CE) signaling.

4. The method of claim 2, further comprising:
obtaining a list of candidate cell configurations for failure recovery among the plurality of configurations for the candidate cells for the cell switch;
detecting the cell switch failure upon an expiry of the timer; and
based on a candidate cell configuration in the list of candidate cell configurations, performing a failure recovery procedure to a candidate cell related to the candidate cell configuration.

5. The method of claim 4, wherein the list of candidate cell configurations is included in at least one of the message, the configuration for the candidate cell, or the cell switch command.

6. The method of claim 1, wherein the configuration for the candidate cell comprises the plurality of timer values of the timer for detecting the cell switch failure.

7. The method of claim 1, wherein the cell switch type comprises at least one of a random access channel (RACH)-less cell switch or a RACH-based cell switch,
wherein the plurality of timer values comprise at least one of:
a first timer value related to the RACH-less cell switch; or
a second timer value related to the RACH-based cell switch,
wherein the RACH-less cell switch comprises skipping a random access to the candidate cell while the timer with the first timer value is running, and
wherein the RACH-based cell switch comprises performing a contention-free random access (CFRA) or a contention-based random access (CBRA) to the candidate cell while the timer with the second timer value is running.

8. The method of claim 1, wherein the cell switch type comprises at least one of a random access channel (RACH)-less cell switch, a contention-free random access (CFRA)-based cell switch, or a contention-based random access (CBRA)-based cell switch,
wherein the plurality of timer values comprise at least one of:
a first timer value related to the RACH-less cell switch;
a second timer value related to the CFRA-based cell switch; or
a third timer value related to the CBRA-based cell switch,
wherein the RACH-less cell switch comprises skipping a random access to the candidate cell while the timer with the first timer value is running,
wherein the CFRA-based cell switch comprises performing a CFRA to the candidate cell while the timer with the second timer value is running, and
wherein the CBRA-based cell switch comprises performing a CBRA to the candidate cell while the timer with the third timer value is running.

9. The method of claim 1, further comprising:
determining the cell switch type based on at least one of a random access channel (RACH)-skip condition or whether contention-free random access (CFRA) resources are available to the UE; and
determining the timer value related to the determined cell switch type,
wherein the RACH-skip condition comprises at least one of:
a condition that timing advance (TA) information for the candidate cell and a beam indication of the candidate cell are included in the cell switch command;
a condition that a TA for the candidate cell is valid; or
a condition that no beam failure is detected on the candidate cell.

10. The method of claim 9, wherein the cell switch type comprises at least one of a random access channel (RACH)-less cell switch or a RACH-based cell switch,
wherein the cell switch type is determined as the RACH-less cell switch based on the RACH-skip condition being satisfied, and
wherein the cell switch type is determined as the RACH-based cell switch based on the RACH-skip condition being not satisfied.

11. The method of claim 9, wherein the cell switch type comprises at least one of a random access channel (RACH)-less cell switch, a contention-free random access (CFRA)-based cell switch, or a contention-based random access (CBRA)-based cell switch,
wherein the cell switch type is determined as the RACH-less cell switch based on the RACH-skip condition being satisfied,
wherein the cell switch type is determined as the CFRA-based cell switch based on the RACH-skip condition being not satisfied and the CFRA resources being available to the UE, and
wherein the cell switch type is determined as the CBRA-based cell switch based on the RACH-skip condition being not satisfied and the CFRA resources being not available to the UE.

12. The method of claim 1, wherein the cell switch comprises a layer 1 (L1)/layer 2 (L2)-triggered mobility (LTM), and
wherein the cell switch command comprises an LTM command.

13. The method of claim 1, wherein the UE is in communication with at least one of a mobile device, a network, or autonomous vehicles.

14. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
receiving, from a network, a message comprising a configuration for a candidate cell for a cell switch, and a plurality of timer values of a timer for detecting a cell switch failure, wherein each of the plurality of timer values is related to a corresponding cell switch type;
receiving, from the network, a cell switch command for the candidate cell;
initiating the cell switch to the candidate cell based on the cell switch command, wherein the timer with a timer value among the plurality of timer values is started upon the UE initiating the cell switch, and the timer value is related to a cell switch type of the cell switch to be performed; and
performing the cell switch to the candidate cell while the timer is running.

15. (canceled)

16. A network node configured to operate in a wireless communication system, the network node comprising:
at least one transceiver;
at least one processor; and
at least one memory operatively coupled to the at least one processor and storing instructions that, based on being executed by the at least one processor, perform operations comprising:
transmitting, to a user equipment (UE), a message comprising a configuration for a candidate cell for a cell switch, and a plurality of timer values of a timer for detecting a cell switch failure, wherein each of the plurality of timer values is related to a corresponding cell switch type; and
transmitting, to the UE, a cell switch command for the candidate cell,
wherein the cell switch to the candidate cell is initiated based on the cell switch command,
wherein the timer with a timer value among the plurality of timer values is started upon the UE initiating the cell switch, and the timer value is related to a cell switch type of the cell switch to be performed, and
wherein the cell switch to the candidate cell is performed while the timer is running.

17.-20. (canceled)
